(19) United States
(12) Patent Application Publication
(10) Pub. No.: US 2010/0258017 A1
(43) Pub. Date: Oct. 14, 2010

(54) Print Media Slitter

(76) Inventors: Kevin T. Kersey, San Diego, CA (US); Timothy J. Carlin, San Diego, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/421,886

(22) Filed: Apr. 10, 2009

(51) Int. Cl. B41F 13/56

(52) U.S. Cl. 101/227

(57) ABSTRACT

In one embodiment, a media slitter includes first and second rotary slitter blades and first and second pairs of rotatable media transport rollers positioned along opposite first and second sides of a media path. Each pair of transport rollers is configured to engage the print media simultaneously with the other pair of transport rollers and move the print media along the media path. A first one of the media transport rollers in each pair of transport rollers is positioned adjacent to and outboard from a corresponding one of the slitter blades on an axis of rotation common to the first transport rollers and the slitter blades.

### BACKGROUND

In some photo printers, the edges of the paper on which a photograph has been printed are trimmed as the photograph is discharged from the printer. For example, when printing 5″×7″ size photographs on 8″ wide photographic paper, a ½″ wide strip is trimmed from each edge of the paper. The star wheel discharge paper drive mechanism used in some inkjet photo printers, however, may not always have sufficient traction to securely drive the photographs along the discharge path if there are significant skewing forces acting on the paper, such as may occur when trimming the edges of the paper.

### DRAWINGS

FIG. 1 is a block diagram illustrating one embodiment of an inkjet printer.

FIG. 2 is an elevation and partial section view illustrating one embodiment of a media path for an inkjet photo printer.

FIGS. 3 and 4 are perspective views illustrating one embodiment of a print media slitter positioned along a printer's discharge path for trimming the edges from the print media. The media slitter is shown in a disabled position in FIG. 3 and in the enabled position in FIG. 4.

FIGS. 5 and 6 are more detailed perspective views of the slitter shown in FIGS. 3 and 4 with the drive gears omitted to better illustrate some features of the slitter.

FIG. 7 is a perspective view illustrating an alternative embodiment in which the media slitter is adjustable to vary the width of the edge trimmed from the print media.

### DESCRIPTION

Embodiments of the new media slitter were developed to improve traction and minimize skew forces on photographs as the edges of the photograph are trimmed while the photograph is discharged from a photo printer. Embodiments, however, are not necessarily limited to trimming photographs or to the discharge path in a printer. Thus, the embodiments shown in the figures and described below are examples. Other embodiments are possible and nothing in the following description should be construed to limit the scope of the disclosure, which is defined in the Claims.

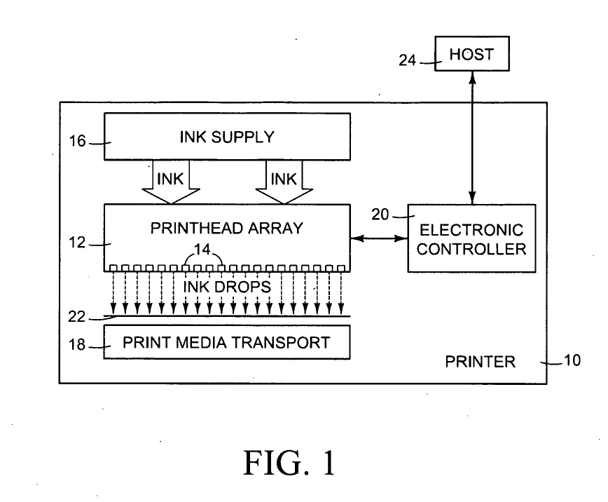

FIG. 1 is a block diagram illustrating an inkjet printer 10 that includes an array 12 of printheads 14, an ink supply 16, a print media transport system 18 and an electronic printer controller 20. Printer 10 illustrates one example of an environment for implementing embodiments of the new media slitter. Printhead array 12 in FIG. 1 represents generally one or more printheads 14 and the associated mechanical and electrical components for ejecting drops of ink or other marking material on to a sheet or continuous web of paper or other print media 22. In operation, printer controller 20 selectively energizes the ink ejector elements in a printhead, or group of printheads, in the appropriate sequence to eject ink on to media 22 in a pattern corresponding to the desired printed image.

Printhead array 12 and ink supply 16 may be housed together as a single unit or they may comprise separate units. Printhead array 12 may be a mostly stationary, larger unit (with or without supply 16) spanning the width of print media 22. Alternatively, printhead array 12 may be a smaller unit that is scanned back and forth across the width of media 22 on a moveable carriage. Media transport system 18 advances print media 22 lengthwise past printhead array 12. For a stationary printhead array 12, media transport 18 may advance media 22 continuously past the array 12. For a scanning printhead array 12, media transport 18 may advance media 22 incrementally past array 12, stopping as each swath is printed and then advancing media 22 for printing the next swath. Controller 20 may receive print data from a computer or other host device 24 and, when necessary, process that data into printer control information and image data. Controller 20 controls the movement of the operative components of media transport system 18. And, as noted above, controller 20 is electrically connected to printhead array 12 to energize the printhead ejector elements to eject ink drops on to media 22. By coordinating the relative position of array 12 and media 22 with the ejection of ink drops, controller 20 produces the desired image on media 22 according to the print data received from host device 24.

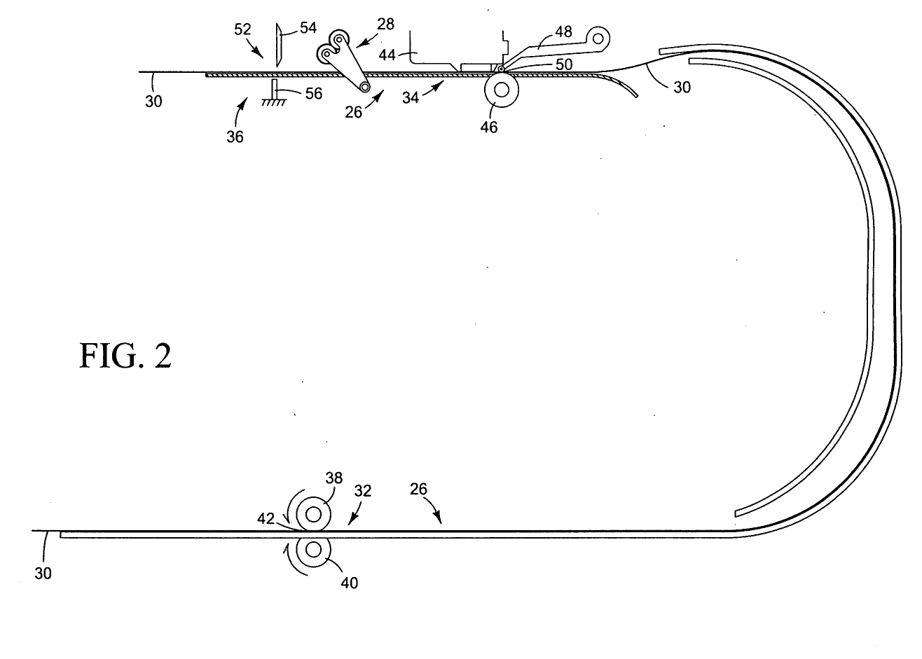

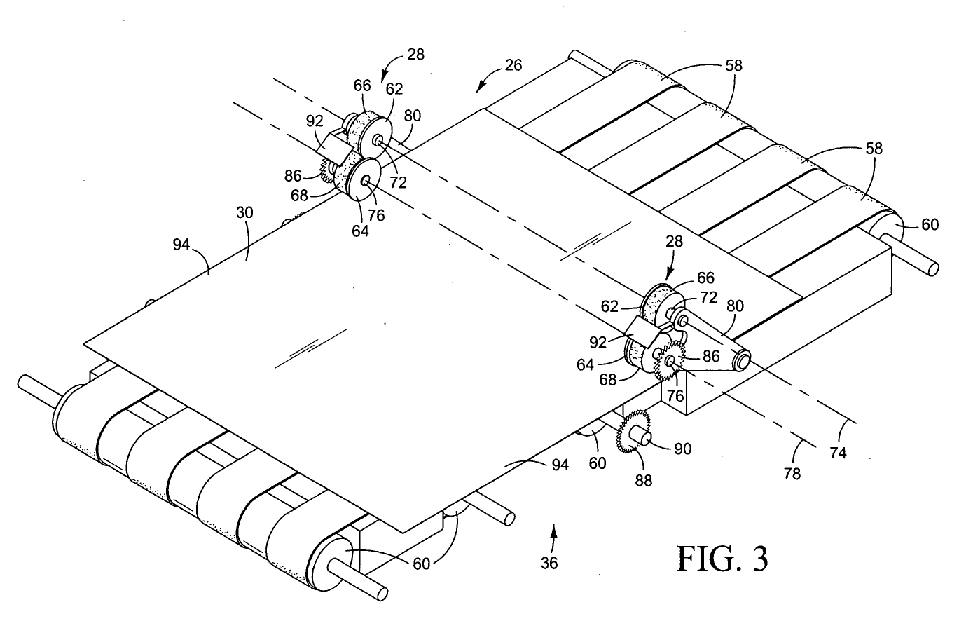

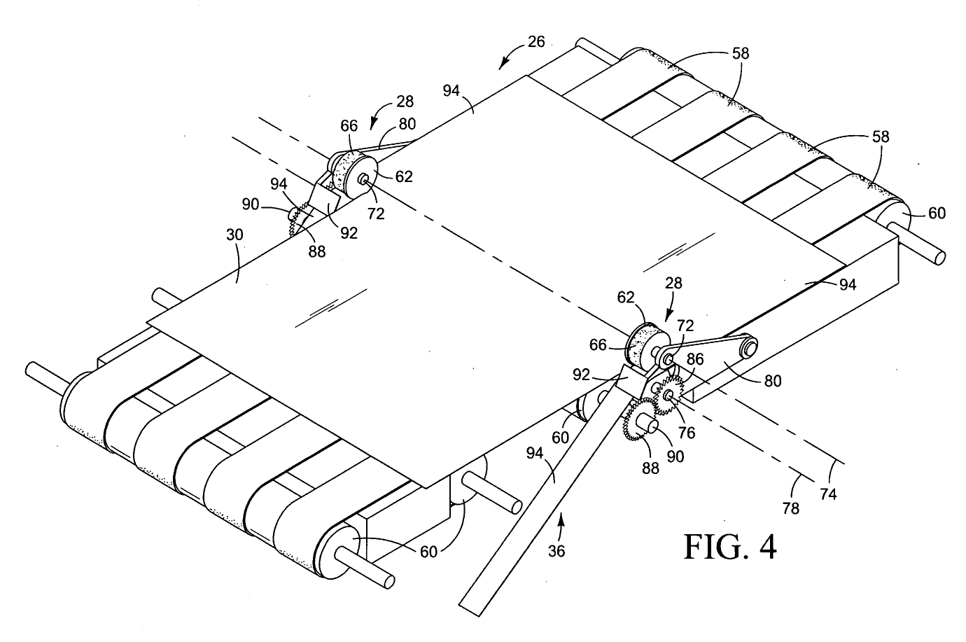

FIG. 2 is an elevation and partial section view illustrating an example media path 26 for an inkjet photo printer, such as printer 10 shown in FIG. 1, that includes a media edge slitter 28 according to an embodiment of the disclosure. FIGS. 3 and 4 are perspective views illustrating media edge slitters 28 in more detail. (Only one edge slitter 28 is visible in FIG. 1.) Media edge slitters 28 are shown in a disabled position in FIGS. 2 and 3, out of media path 26, and in the enabled position in FIG. 4, in media path 26. Referring first to FIG. 2, photo paper or other print media 30 transported along media path 26 follows a semicircular path from an input zone 32 on path 26 through a print zone 34 to a discharge zone 36. A set of first media transport rollers 38 and 40 form a nip 42 for gripping and moving print media 30 along media path 26 through input zone 32 to print zone 34. Print zone 34 is depicted generally as including an ink cartridge or other printhead array 44 and a transport roller 46 bearing against an idler arm 48 to form a nip 50 that moves media 30 past printhead array 44 to discharge zone 36. The side edges of print media 30 may be trimmed, as described in more detail below, at discharge zone 36 by engaging edge slitter 28. The leading edge of print media 30 may be trimmed, or media 30 cut to desired lengths, by engaging a cross cut slitter 52. Although cross cut slitter 52 is depicted as including a cutting wheel 54 and an anvil 56, any suitable cutting mechanism may be used.

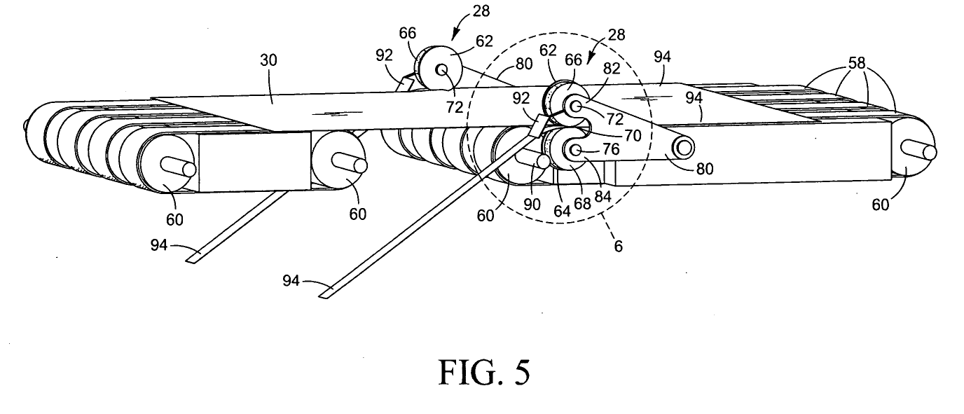

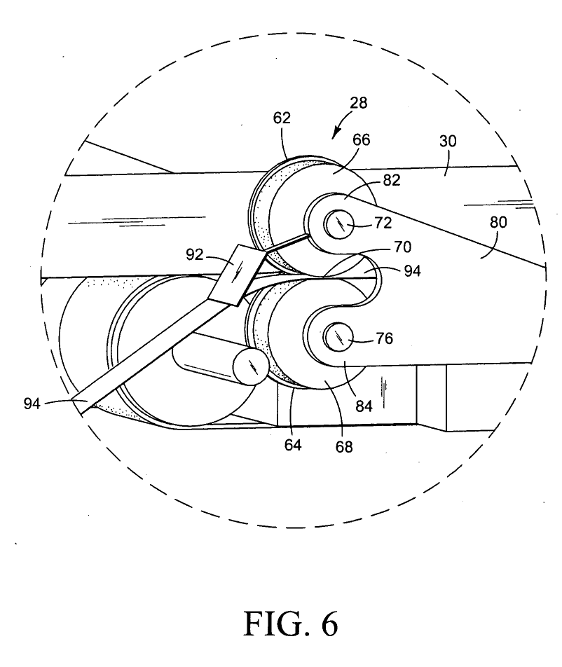

FIGS. 5 and 6 are more detailed perspective views of media edge slitters 28 with the drive gears omitted to better illustrate some features of slitter 28. Referring now to FIGS. 3-6, print media 30 is moved through discharge zone 36 on transport belts 58 driven by one or more in a set of drive drums 60. A belt/drum drive for discharging media 30 is just one example of a suitable media transport configuration. Other configurations are possible. For example, a star wheel configuration might also be used. A media edge slitter 28 is positioned along each side of media path 26 in discharge zone 36. Each edge slitter 28 includes a pair or rotary slitter blades 62 and 64 positioned with respect to one another such that print media 30 passing between each pair of blades 62 and 64 is slit, as shown in FIGS. 4-6. Each edge slitter 28 also includes a pair of transport rollers 66 and 68 positioned with respect to one another for engaging print media 30 at a nip 70 and advancing media 30 along path 26. Each transport roller 66 is mounted to a shaft 72. Shafts 72 define an axis of rotation 74 common to both shafts 72. Alternatively, rollers 66 may be mounted to a single shaft (not shown) that extends fully across media path 26. Each transport roller 68 is mounted to a shaft 76. Shafts 76 define an axis of rotation 78 common to both shafts 76.

Each shaft 72 and 76 is mounted to a forked swing arm 80 through a bushing or other suitable bearing (not shown) that allows shafts 72, 76 to rotate freely relative to swing arm 80. Shafts 72 are mounted to swing arm forks 82 and shafts 76 are mounted to swing arm forks 84. Each rotary slitter blade 62 is mounted to a corresponding transport roller 66 and/or to a corresponding shaft 72 such that blades 62 rotate about axis of rotation 74. Thus, axis 74 is common to blades 62, rollers 66 and shafts 72. Each rotary slitter blade 64 is mounted to a corresponding transport roller 68 and/or to a corresponding shaft 76 such that blades 64 rotate about axis of rotation 78. Thus, axis of rotation 78 is common to blades 64, rollers 68 and shafts 76. Each shaft 76 is fitted with a gear 86 that engages a drive gear 88 on drum shaft 90 when each edge slitter 28 is in the enabled position shown in FIG. 4. Gears 86 and 88 are omitted from FIGS. 5 and 6 to better illustrate other features of slitters 28. A deflector 92 extending from swing arm 80 deflects each edge 94 that has been trimmed from print media 30 down away from media path 26, into a waste bin (not shown) for example.

When edge trimming is desired, edge slitters 28 are rotated down on swing arms 80 at the direction of controller 20 (FIG. 1) before the leading edge of media 30 reaches slitters 28 from a disabled position out of media path 26, shown in FIG. 3, to the enabled position in media path 26, shown in FIG. 4-6. The use of a swing arm 80 to disable and enable slitters 28 allows slitter blades 62 and 64 and rollers 66 and 68 to remain fully engaged at nip 70 all times, thus avoiding the challenges encountered in opening and closing nip 70 on a stationary slitter (a slitter that is always in the media path). As shown in FIG. 4, each edge slitter gear 86 engages a drum gear 88 when edge slitters 28 are in the engaged position to drive edge slitter transport rollers 68 against rollers 66 at nip 70. When edge trimming is no longer desired, and the trailing edge of media 30 has cleared slitters 28, edge slitters 28 may be rotated back up to the disabled position out of media path 26.

Print media 30 moving through discharge zone 36 is pulled into and through nip 70 to advance media 30 along media path 26 as edges 94 are trimmed off media 30. One or both transport rollers 66 and 68 may be formed with an elastomeric or other suitable friction enhancing surface to help grip print media 30 at nip 70. Since both media edges 94 are engaged simultaneously at nips 70 and rollers 66 and 68 are rotating the same speed on the same axes of rotation 74 and 78, there are few if any skew forces acting on media 30 as it passes through slitters 28. Rollers 66 and 68 engaging media 30 drive the trimmed edges 94 forward into deflectors 92. And, because rollers 66 and 68 engage print media 30 at edges 94, at the outer margins where there has been no printing, there is little risk of rollers 66, 68 slipping at nip 70 or smearing ink.

Although other configurations could be used, it is expected that in most applications gears 86, 88 and edge slitter transport rollers 66, 68 will be configured to advance media 30 at the same speed as transport belts 28. Also, while two sharpened blades 62 and 64 are shown for each slitter 28, other cutting mechanisms could be used. For example, it may be desirable in some applications to use only one sharpened blade bearing against a dull blade or a blunt rotary anvil to slit media 30.

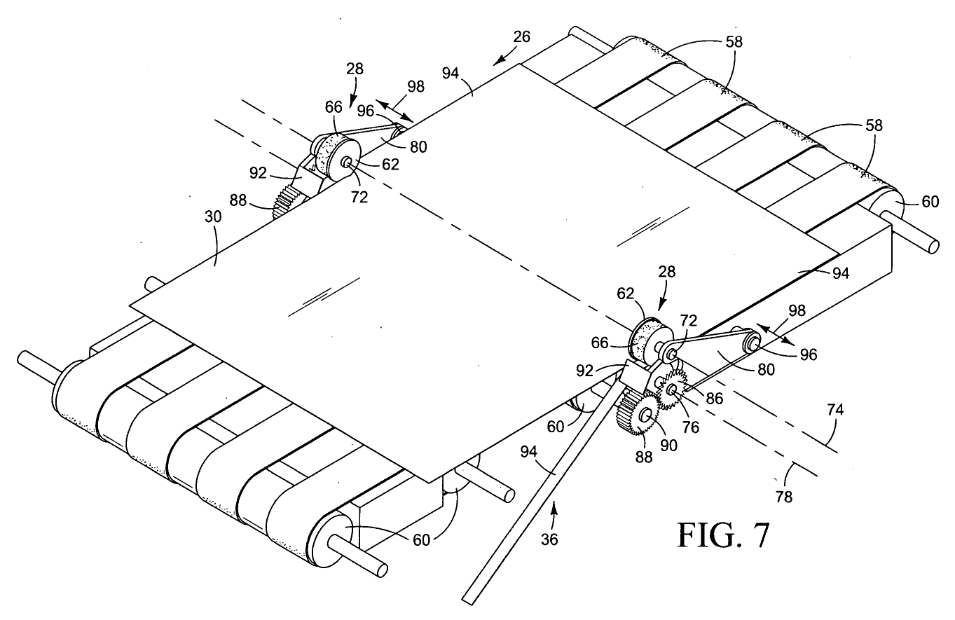

In an alternative embodiment shown in FIG. 7, edge slitters 28 may be adjusted laterally along a shaft 96 mounting each pivot arm 80 to vary the width of edge 94 trimmed from media 30, as indicated by arrow 98. In FIG. 7, each slitter 28 is positioned outboard from the position shown in FIG. 4 so that edge 94 trimmed from media 30 is narrower by about ½, for example.

The present disclosure has been shown and described with reference to the foregoing exemplary embodiments. It is to be understood, however, that other forms, details and embodiments may be made without departing from the spirit and scope of the disclosure which is defined in the following claims.

What is claimed is:

1. A print media slitter, comprising:
a first rotary slitter blade positioned along a first side of a media path;
a second rotary slitter blade positioned along a second side of the media path opposite the first side;
a first pair of rotatable media transport rollers positioned along the first side of the media path;
a second pair of rotatable media transport rollers positioned along the second side of the media path;
each pair of transport rollers configured to engage the print media simultaneously with the other pair of transport rollers and move the print media along the media path; and
a first one of the media transport rollers in each pair of transport rollers positioned adjacent to and outboard from a corresponding one of the slitter blades on an axis of rotation common to the first transport rollers and the slitter blades.

2. The slitter of claim 1, wherein:
the first one of the media transport rollers in the first pair and the first slitter blade are mounted on a first shaft extending along the axis of rotation; and
the first one of the media transport rollers in the second pair and the second slitter blade are mounted on a second shaft extending along the axis of rotation.

3. The slitter of claim 2, further comprising
a first pivotable arm mounting the first shaft; and
a second pivotable arm mounting the second shaft;
wherein the first arm and the second arm are each pivotable simultaneously with one another between:
a first position in which the transport rollers and the slitter blades are positioned in the media path so that the transport rollers can engage the print media and move the print media along the media path past the slitter blades; and
a second position in which the transport rollers and the slitter blades are positioned out of the media path.

4. The slitter of claim 3, further comprising a deflector positioned downstream from the slitter blades for deflecting an edge part of print media slit from a main part of the print media away from the media path.

5. The slitter of claim 1, wherein one of the transport rollers in each pair comprises a driven roller and the other transport roller in each pair comprises an idler roller.

6. A print media slitter, comprising:
a pair of rotary slitter blades positioned along one side of a media path for slitting print media moving along the media path through the slitter blades;
a pair of rotatable media transport rollers positioned along the side of the media path for engaging the print media and moving the print media along the media path;
a first one of the media transport rollers positioned outboard from a first one of the slitter blades on a first axis of rotation common to the first transport roller and the first slitter blade; and
a second one of the media transport rollers positioned outboard from a second one of the slitter blades on a second axis of rotation common to the second transport roller and the second slitter blade.

7. The slitter of claim 6, wherein the first slitter blade and the first transport roller are mounted on a first shaft extending along the first axis of rotation and the second slitter blade and the second transport roller are mounted on a second rotatable shaft extending along the second axis of rotation.

8. The slitter of claim 7, further comprising a pivotable arm mounting the first shaft and the second shaft, the arm pivotable between:
a first position in which the transport rollers and the slitter blades are positioned in the media path so that the transport rollers can engage the print media and move the print media along the media path through the slitter blades; and
a second position in which the transport rollers and the slitter blades are positioned out of the media path.

9. The slitter of claim 6, wherein the first transport roller is positioned immediately adjacent to the first slitter blade and the second transport roller is positioned immediately adjacent to the second slitter blade.

10. The slitter of claim 9, further comprising a deflector positioned downstream from the slitter blades for deflecting an edge part of print media slit from a main part of the print media away from the media path.

11. The slitter of claim 6, wherein the first transport roller comprises a driven roller and the second transport roller comprises an idler roller.

12. A print media slitter, comprising:
a first pair of rotary slitter blades positioned along a first side of a media path;
a second pair of rotary slitter blades positioned along a second side of the media path opposite the first side;
a first pair of rotatable media transport rollers positioned along the first side of the media path;
a second pair of rotatable media transport rollers positioned along the second side of the media path;
one or both transport rollers in each pair being a driven roller and each pair of transport rollers configured to engage the print media and move the print media along the media path;
a first one of the media transport rollers in each pair positioned adjacent to and outboard from a corresponding first one of the slitter blades in each pair on a corresponding first shaft in a pair of first shafts;
a second one of the media transport rollers in each pair positioned adjacent to and outboard from a corresponding second one of the slitter blades in each pair on a corresponding second shaft in a pair of second shafts each oriented parallel to a first shaft; and
a pair of pivotable arms each mounting one of the first shafts and one of the second shafts, each arm pivotable simultaneously with the other arm between:
a first position in which the transport rollers and the slitter blades are positioned in the media path so that the transport rollers can engage the print media and move the print media along the media path through the slitter blades; and
a second position in which the transport rollers and the slitter blades are positioned out of the media path.

13. The slitter of claim 12, wherein each pair of rollers and blades is adjustable laterally along a shaft mounting the corresponding pivotable arm.

14. The slitter of claim 12, wherein the slitter blades and the transport rollers are positioned downstream from a print zone along the media path and the slitter further comprises a deflector positioned downstream from the slitter blades for deflecting an edge part of print media slit from a main part of the print media away from the media path.
